(19) United States
(12) Patent Application Publication
(10) Pub. No.: US 2023/0320252 A1
(43) Pub. Date: Oct. 12, 2023

(54) A COMPUTER-IMPLEMENTED METHOD FOR ESTIMATING A PRODUCT CONSUMPTION OF AN AGRICULTURAL PRODUCT FOR AN AGRICULTURAL FIELD

(71) Applicant: BASF AGRO TRADEMARKS GMBH, Ludwigshafen (DE)

(72) Inventors: Jonas MICKEL, Köln (DE); Maria TACKENBERG, Münster (DE); Thomas LECHNER, Münster (DE); Clemens VON HARDENBERG, Köln (DE)

(21) Appl. No.: 18/025,082

(22) PCT Filed: Sep. 17, 2021
(86) PCT No.: PCT/EP2021/075683

§ 371 Date: Mar. 7, 2023

(30) Foreign Application Priority Data
Sep. 18, 2020 (EP) 20196963.1

(51) Int. Cl. A01B 79/00; A01B 69/00

(52) U.S. Cl. CPC A01B 79/005; A01B 69/007

(57) ABSTRACT

A computer-implemented method for estimating a product consumption of an agricultural product for an agricultural field, comprising the steps: providing a target application rate map (10) comprising an application rate distribution of the agricultural product of the agricultural field, wherein the application rate distribution comprises different target areas with predetermined 5 application rates of the agricultural product (S100); providing a route (34, 52) of an agricultural vehicle and/or an application device of the agricultural vehicle through the agricultural field for applying the agricultural product (S200); providing a working width (37, 52) of the agricultural vehicle and/or the application device of the agricultural vehicle; determining application rates of the agricultural vehicle and/or the application device of the agricultural vehicle at least based on 10 the route (34, 52) of the agricultural vehicle and/or the application device of the agricultural vehicle through the agricultural field (S300); determining the product consumption for the agricultural field based on the determined application rates and the working width (37, 53) of the agricultural vehicle and/or the application device of the agricultural vehicle (S400). 15

### FIELD OF THE INVENTION

The present invention relates to a computer-implemented method for estimating a product consumption, a computer program element for operating a user device, a computer program element for operating a server, a user device for performing such a method, a use of the determined product consumption, a use of an application rate map, routes of an agricultural vehicle in such a method, a system for estimating a product consumption.

### BACKGROUND OF THE INVENTION

Agricultural management decisions as timing, dosing and selection of planting date, crop protection measures, fertilizer application or harvesting operations are driven by environmental factors. In terms of timing and dosage, a farmer/agronomists usually rely on the information provided by manufacturers of agricultural products, e.g. seeds, growth promoters, fungicides, etc. However, these information are generalized statements which do not take into account the specific details of a particular field. Agricultural fields may differ in their requirements for product consumption (e.g. fertilizer) across the agricultural field due different environmental properties. Work preparation for an agricultural vehicle is therefore very challenging.

In view of this it is been found that a further need exists to provide a method for preparing an application of an agricultural product on an agricultural field, preferably to provide an improved method for preparing an application of an agricultural product on an agricultural field.

### SUMMARY OF THE INVENTION

It is therefore an object of the present invention to provide a method for preparing an application of an agricultural product on an agricultural field, preferably to provide an improved method for preparing an application of an agricultural product on an agricultural field.

A first aspect of the present disclosure relates to a computer-implemented method for estimating a product consumption of an agricultural product for an agricultural field, comprising the steps: providing a target application rate map comprising an application rate distribution of the agricultural product of the agricultural field, wherein the application rate distribution comprises different target areas with predetermined application rates of the agricultural product; providing a route of an agricultural vehicle and/or an application device of the agricultural vehicle through the agricultural field for applying the agricultural product; providing a working width of the agricultural vehicle and/or the application device of the agricultural vehicle; determining application rates of the agricultural vehicle and/or the application device of the agricultural vehicle at least based on the route of the agricultural vehicle and/or the application device of the agricultural vehicle through the agricultural field; determining the product consumption for the agricultural field based on the determined application rates and the working width of the agricultural vehicle and/or the application device of the agricultural vehicle or based on the working width of the agricultural vehicle and/or the application device of the agricultural vehicle

In other words, the present disclosure proposes to determine the real product consumption of an agricultural vehicle and/or agricultural device that applies the product (e.g. a fertilizer) on an agricultural field. The determining of the real product consumption is based on the finding that there is a deviation of the ideal product consumption directly derived from the target application rate map and the real product consumption resulting from the agricultural vehicle driving through the agricultural field. The real application rate applied on the field depends on the position/route of the agricultural vehicle and/or agricultural device. In case the position of the agricultural vehicle and/or agricultural device is in a target area with a specific application rate and the working width of the agricultural vehicle and/or agricultural device extends to a neighboring area with a different application rate, only one application rate is applied on both areas. Hence, the application rate on the neighboring area is wrong and therefor a deviation from the target application rate of the neighboring area occurs. This deviation results in a different product consumption for the agricultural field in comparison to the target application rate map. The disclosed method calculates the real product consumption. This may be advantageous due to omission of an additional charge of a product tank of the agricultural vehicle and/or application device in case of too little initial product amount in the tank. This may be advantageous due to omission of expensive disposal of not applied product amounts in case of too high initial product amount in the tank. This may be advantageous to increase a treatment efficiency of the agricultural field and therefor result in an increase of yield of the agricultural field.

The term target application rate map is to be understood broadly in the present case and comprises a map of an agricultural field, wherein the agricultural field is divided in areas associated with a specific application rate. The term product consumption means in the present case the necessary amount of a product for a treatment of an agricultural field (e.g. 50 kg fertilizer A or 65 l pesticide B). The terms “product consumption” and “product usage amount” are used synonymously. The term agricultural product is to be understood broadly in the present case comprises any product to be used for an agricultural treatment. Preferably, the term agricultural product comprises plant growth regulators (PGRs), plant health promoters, nitrification inhibitors, denitrification inhibitors, urease inhibitors, fertilizers, nutrients, seeds, water, pesticides such as herbicides, fungicides, insecticides, nematicides, acaricides, molluscicides, rodenticides, repellents, attractants, and/or biocides. More preferably, the term agricultural product comprises pesticides such as herbicides, fungicides, insecticides, nematicides, acaricides, molluscicides, rodenticides, repellents, attractants, and/or biocides. Most preferably, the term agricultural product comprises pesticides such as herbicides, fungicides, and/or insecticides. In another preferred embodiment, the agricultural product is in a liquid form. The term application rate means in the present case an amount of product per area (e.g. 50 kg/ha or 65 l/ha). The term route means in the present case a path of the agricultural vehicle through the agricultural field. The route is preferably derived from tramlines in an agricultural field. The term agricultural vehicle is to be understood broadly in the present case and comprises any vehicle, which is configured to drive through an agricultural field. Preferably, the term comprises a tractor, a commercial vehicle, a sport utility vehicle and/or a drone. The term application device is to be understood broadly in the present case and comprises any device configured to apply an agricultural product on an agricultural field. Preferably, the term application device comprises a sprayer, sowing machine, spreader. Preferably the application device is configured to be mounted on the agricultural vehicle.

In an embodiment, a method is provided, wherein the step of determining the application rates comprises determining a position of the agricultural vehicle and/or the application device of the agricultural vehicle in the target application rate map. The position of the agricultural vehicle and/or the application device of the agricultural vehicle may be determined by analyzing the route of the agricultural vehicle and/or the application device of the agricultural vehicle through the target areas of the target application rate map. The route reveals every position of the agricultural vehicle and/or the application device of the agricultural vehicle in the target application rate map. This may be advantageous to determine the real applied application rate along the route.

In an embodiment, a method is provided, wherein the step of determining the product consumption comprises determining a sub-area with a sub-area application rate based on the working width of the agricultural vehicle and/or the application device and an intersection of the route with a target area border of a target area. The term working width means in the present case a translatory dimension of the agricultural vehicle and/or the application device of the agricultural vehicle, which represents a width of application of the agricultural product. The term sub-area means in the present case an area, which is derived from the route, the working width, an intersection of the route with an target area border and one application rate (i.e. sub-area application rate), wherein the one application rate will in reality be applied to the sub-area. This may be advantageous to determine the real applied application rate on the corresponding sub-areas of the agricultural field.

In an embodiment, a method is provided, wherein the step of determining the product consumption of the agricultural field comprises a summation of the product consumption for the sub-areas, wherein the product consumption for the sub-areas is determined by multiplying the area of the sub-area and the sub-area application rate. This may be advantageous to determine the real product consumption for the agricultural field.

In an embodiment, the method further comprises the step of determining a formulation and/or mixture of the agricultural product based on the product consumption for the agricultural field. The agricultural product may comprise different sub products. Based on the product consumption for the agricultural field amounts of the different sub products are chosen, which serve as basis for the formulation and/or mixture of the agricultural product. This may be advantageous to increase the yield of the agricultural field.

In an embodiment, a method is provided, wherein the target application rate map is based on performance/yield zones of the agricultural field. In other words the application rate considers different yields of the agricultural fields. This may be advantageous to increase a treatment efficiency and/or a yield of the entire agricultural field.

In an embodiment, a method is provided, wherein the route is based on a tramline of the agricultural vehicle and the working width of the agricultural vehicle or the application device of the agricultural vehicle. The term tramline means in the present case the possible paths, which can be followed by the agricultural vehicle. This may be advantageous to ensure a complete coverage of the field and therefore to increase the yield of the agricultural field.

In an embodiment, the method further comprises the step of identifying area overlaps when applying the agricultural product based on the route and the working width and removing the area overlaps when estimating the product consumption for the agricultural field. The area overlaps may occur due to the geographical circumstances and geometrical dimensions of the agricultural vehicle and/or agricultural device. In case the agricultural vehicle and/or the application device are provided with a section control, area overlaps can be detected and by adjusting the working width of the agricultural vehicle and/or the application device, the area overlaps can be removed from the application treatment. By removing the area overlaps from the estimating of the product consumption the accuracy of the product consumption may be increased.

In an embodiment, a method is provided, wherein the application rate is provided by a spray rate for applying a fluid and/or by a scattering rate for applying solid. In other words, the method is universally applicable independent from the agricultural product (e.g. solid, fluid, vapor etc.). A further aspect of the present disclosure relates to a computer program element for operating a user device which, when executed on a processor of a user device, instructs the processor to perform steps of the method described above. The term user device is to be understood broadly in the present case and comprises any device configured to perform the method. Preferably, the term user device comprises a tablet, a smartphone and/or a desktop pc. The computer program element might therefore be stored on a computer unit, which might also be part of an embodiment. This computing unit may be configured to perform or induce performing of the steps of the method described above. Moreover, it may be configured to operate the components of the below described user device and/or system. The computing unit can be configured to operate automatically and/or to execute the orders of a user. A computer program may be loaded into a working memory of a data processor. The data processor may thus be equipped to carry out the method according to one of the preceding embodiments. This exemplary embodiment of the invention covers both, a computer program that right from the beginning uses the invention and computer program that by means of an update turns an existing program into a program that uses invention. Further on, the computer program element might be able to provide all necessary steps to fulfill the procedure of an exemplary embodiment of the method as described above. According to a further exemplary embodiment of the present invention, a computer readable medium, such as a CD-ROM, USB stick or the like, is presented wherein the computer readable medium has a computer program element stored on it which computer program element is described by the preceding section. A computer program may be stored and/or distributed on a suitable medium, such as an optical storage medium or a solid state medium supplied together with or as part of other hardware, but may also be distributed in other forms, such as via the internet or other wired or wireless telecommunication systems. However, the computer program may also be presented over a network like the World Wide Web and can be downloaded into the working memory of a data processor from such a network. According to a further exemplary embodiment of the present invention, a medium for making a computer program element available for downloading is provided, which computer program element is arranged to perform a method according to one of the previously described embodiments of the invention.

A further aspect of the present disclosure relates to a computer program element for operating a server, which when executed on a processor of the server, instructs the processor to perform steps of the method described above.

A further aspect of the present disclosure relates to user device comprising a programmable controller, which is configured to perform steps of the method described above. The user device may be a desktop pc, smartphone or tablet.

A further aspect relates to a use of the determined product consumption determined by the method described above for controlling a controller unit of a loading or filling station for the agricultural product into the agricultural vehicle and/or application device.

A further aspect relates to a use of a target application rate map, routes of an agricultural vehicle through an agricultural field in a method described above.

A further aspect relates to a system for estimating a product consumption of an agricultural product for an agricultural field, comprising: a first receiving unit configured to receive a target application rate map comprising an application rate distribution of the agricultural product of the agricultural field, wherein the application rate distribution comprises different target areas with a specific application rate limited by one application rate border; a second receiving unit configured to receive a route of an agricultural vehicle through the agricultural field for applying the agricultural product; a first determining unit configured to determine application rates of the agricultural vehicle and/or an application device of the agricultural vehicle at least based on the route of the agricultural vehicle through the agricultural field and a working width of the application device; a second determining unit configured to determine the product consumption for the agricultural field based on the determined application rates. The receiving units and/or determining units may be distributed on different hardware units or combined in a single hardware. Further the receiving units and/or determining units may be virtual units (i.e. software units).

A further aspect relates to a method for applying a product on an agricultural field, comprising the steps: providing a determined product consumption of an agricultural product for an agricultural field according to a method as described above; controlling a controller unit of a loading or filling station for the agricultural product when filling the agricultural product into an agricultural vehicle and/or an application device; applying the agricultural product onto the agricultural field.

A further aspect relates to a system for applying a product on an agricultural field, comprising: a providing unit for providing a determined product consumption of an agricultural product for an agricultural field according to a method as described above; a controlling unit for controlling a loading or filling station for the agricultural product based on the determined product consumption when filling the agricultural product into an agricultural vehicle and/or an application device; an agricultural vehicle and/or an application device for applying the agricultural product onto the agricultural field.

### BRIEF DESCRIPTION OF THE DRAWINGS

In the following, the invention is described exemplarily with reference to the enclosed figure, in which

FIG. 1 is a target application rate map according to the present disclosure;

FIG. 2 is an application rate map corresponding to FIG. 1 as applied;

FIG. 3 is a flow chart of the method according to the present disclosure;

FIG. 4 is a schematic view of the method according to a first embodiment of the present disclosure;

FIG. 5 is a schematic view of the method according to a second embodiment of the present disclosure;

FIG. 6 illustrates an example embodiment of a system for applying an agricultural product onto an agricultural field; and

FIG. 7 illustrates an example data exchange in a system according to the present disclosure.

### DETAILED DESCRIPTION OF EMBODIMENT

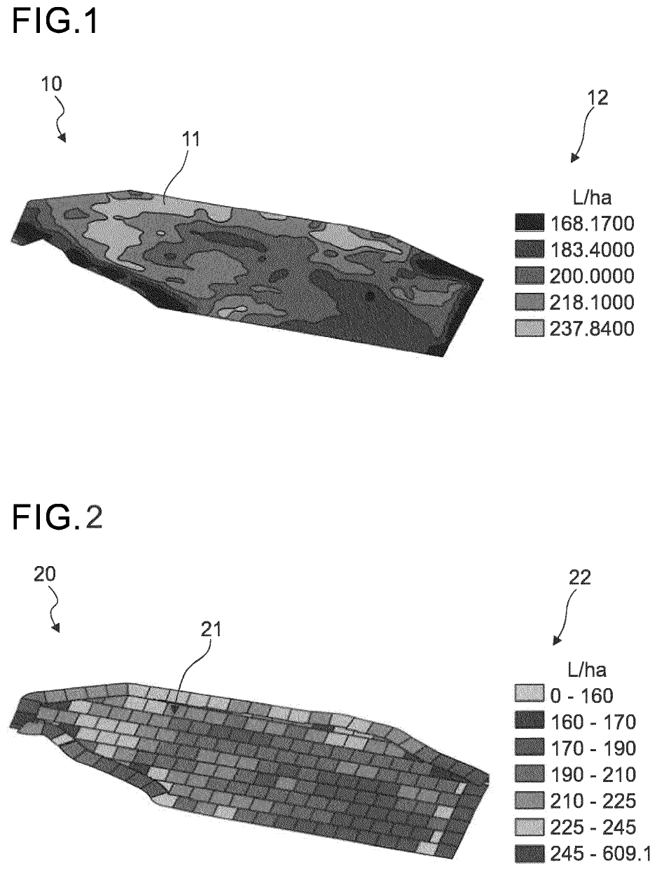

FIG. 1 is a target application rate map 10 according to the present disclosure. The target application rate map 10 relates to an agricultural field to be followed and treated by an agricultural vehicle and/or an agricultural device. The target application rate map 10 comprises different target areas 11 and predetermined application rates illustrated in a greyscale metric 12. The target areas 11 show unequally shapes and sizes and further comprise different predetermined application rates. The target application rate map 12 serves an agricultural vehicle and/or an application device as input for applying an agricultural product.

FIG. 2 is an application rate map 20 corresponding to FIG. 1 as applied. The application rate map 20 shows in comparison to the target application rate map 10 another application rate distribution. The shape and size of the sub areas 21 differ from the target areas 11 and therefore the applied application rates. This results in a deviation of the ideal product consumption and the real product consumption as applied.

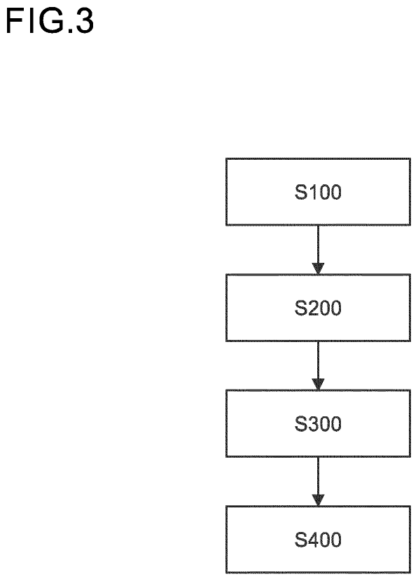

FIG. 3 is a flow chart of the method according to the present disclosure. In a first step S100 a target application rate map comprising an application rate distribution of the agricultural product of the agricultural field is provided, wherein the application rate distribution comprises different target areas with predetermined application rates of the agricultural product. The target application map may be provided from a commercial provider or a government facility. In the next step S200 a route of an agricultural vehicle through the agricultural field for applying the agricultural product is provided. The may be provided from another planning software or from a user via an interface. In step S300 application rates of the agricultural vehicle and/or an application device of the agricultural vehicle are determined at least based on the route of the agricultural vehicle through the agricultural field. The application rate is determined by matching the position along the route of the agricultural vehicle and/or the application device of the agricultural vehicle with target application rate map. The position along the route in the agricultural field reveals the application rate in the target application rate map. The position may be the center of the agricultural vehicle and/or the application device of the agricultural vehicle. In step S400 the product consumption for the agricultural field is determined based on the determined application rates and a working width of the agricultural vehicle and/or the application device. The determining of the product consumption further comprises determining a sub-area with a sub-area application rate based on the working width of the agricultural vehicle and/or the application device and an intersection of the route with a target area border of a target area. The sub-area with one sub-area application rate is created by multiplying a specific length of the route and the working width, wherein the specific length is limited by an intersection of the route and an application rate border. By multiplying the area of the sub-area and the sub-area application rate the product consumption of the sub-area is determined. By summation of the product consumptions of the sub-areas the product consumption of the agricultural field is determined.

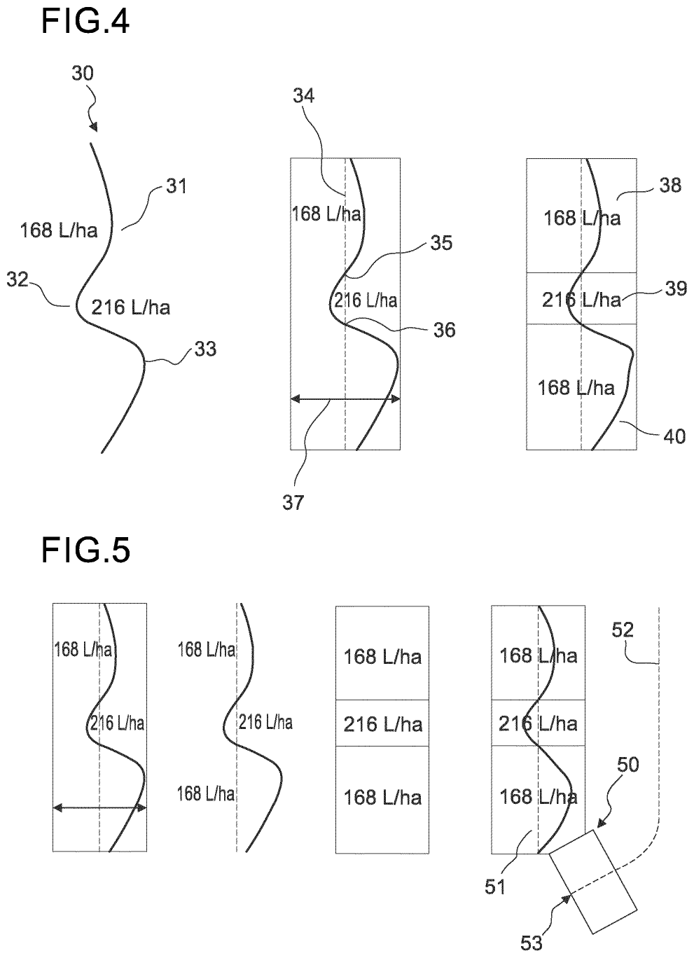

FIG. 4 is a schematic view of the method according to a first embodiment of the present disclosure. An area 30 comprises two different target areas 31 and 32 with two predetermined application rates (i.e. 168 L/ha and 216 L/ha). The target areas 31, 32 are separated from each other target area border 33. The route 34 of the agricultural vehicle intersects the target areas in two points 35, 36. The intersections 35, 36 create with the applications width 37 of the agricultural vehicle the sub-areas 38, 39, 40 with the corresponding sub-area application rates. These sub-areas represent the areas with the application rate applied by the agricultural vehicle and/or the application device of the agricultural vehicle.

FIG. 5 is a schematic view of the method according to a second embodiment of the present disclosure. In contrast to FIG. 4 an area overlap 50 occurs in the sub-area 51. The area overlap is caused by a route 52 parallel running to a first part of the route and further running to the left in the bottom and the corresponding working width 53 of the agricultural vehicle and/or application device of the agricultural vehicle. The agricultural vehicle and/or the application device are provided with a section control, which detects area overlaps and adjusts the working width of the agricultural vehicle and/or the application device in order to remove the area overlap 50 from the application treatment. In case such section control is provided the method disclosed above also removes the area overlap in the estimating of the product consumption for the agricultural field.

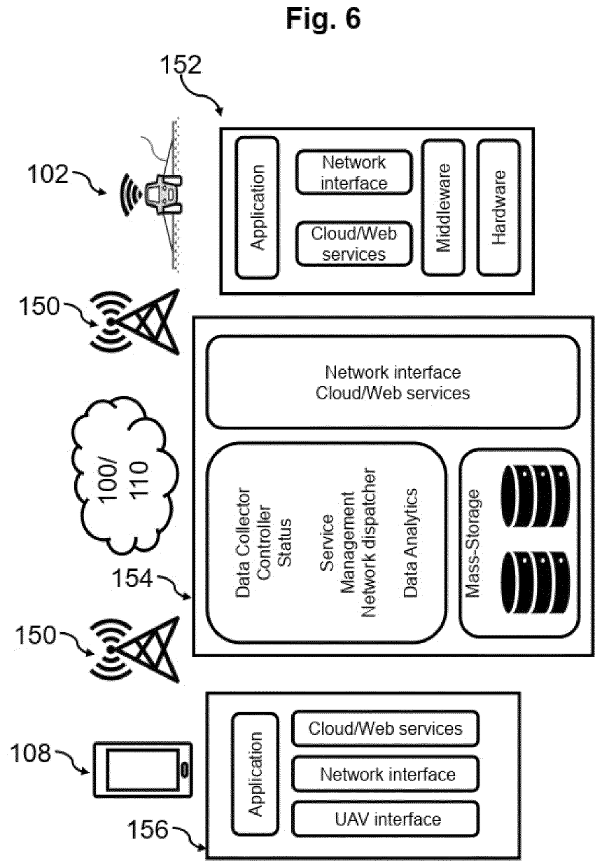

The system in FIG. 6 shows an exemplary distributed system including an agricultural vehicle 102 (e.g. a sprayer), which has been loaded/filled with the agricultural product according to the determined product consumption for the agricultural field, one or more ground station(s) 110, one or more user device(s) 108, and a cloud environment 100. The agricultural vehicle 102 may be a manned or unmanned vehicle which can be controlled autonomously by onboard computers, remotely by a person or partially remotely e.g. by way of initial operation data. The agricultural vehicle 102 may transmit data signals collected from various onboard sensors and actors mounted to the agricultural vehicle 102. Such data may include current movement data such as current speed, battery or fuel level, position, weather or wind speed, field data including treatment operation data such as treatment type, treatment location or treatment mode, monitoring operation data such as field condition data or location data, and/or operation data, such as initial operation data, updated operation data or current operation data. The agricultural vehicle 102 may directly or indirectly send data signals, such as field data or operation data, to the cloud environment 100, the ground station(s) 110 or other agricultural vehicles (not shown). The agricultural vehicle 102 may directly or indirectly receive data signals, such as field data or operation data, from cloud environment 100, the ground station(s) 110 or other agricultural vehicles.

The cloud environment 100 may facilitate data exchange with and between the agricultural vehicle(s) 102, the ground control station(s) 110, and/or user device(s) 108. The cloud environment 100 may be a server-based distributed computing environment for storing and computing data on multiple cloud servers accessible over the Internet. The cloud environment 100 may be a distributed ledger network that facilitates a distributed immutable database for transactions performed by the agricultural vehicle 102, one or more ground station(s) 110 or one or more user device(s) 108. Ledger network refers to any data communication network comprising at least two network nodes. The network nodes may be configured to a) request the inclusion of data by way of a data block and/or b) verify the requested inclusion of data to the chain and/or c) receiving chain data. In such a distributed architecture, the agricultural vehicle(s) 102, one or more ground station(s) 110, one or more user device(s) 108 can act as nodes storing transaction data in data blocks and participating in a consensus protocol to verify transactions. If the at least two network nodes are in a chain the ledger network may be referred to as a blockchain network. The ledger network 100 may be composed of a blockchain or cryptographically linked list of data blocks created by the nodes. Each data block may contain one or more transactions relating to field data or operation data. Blockchain refers to a continuously extendable set of data provided in a plurality of interconnected data blocks, wherein each data block may comprise a plurality of transaction data. The transaction data may be signed by the owner of the transaction and the interconnection may be provided by chaining using cryptographic means. Chaining is any mechanism to interconnect two data blocks with each other. For example, at least two blocks may be directly interconnected with each other in the blockchain. A hash-function encryption mechanism may be used to chain data blocks in a blockchain and/or to attach a new data block in an existing blockchain. A block may be identified by its cryptographic hash referencing the hash of the preceding block.

The agricultural vehicle 102 and the ground control station(s) 103 may share data signals with the user device(s) 108 via the cloud environment 100. Communication channels between the nodes and communication channels, between the nodes and the cloud environment 100 may be established through a wireless communication protocol. A cellular network may be established for the agricultural vehicle 102 to ground station 110, other agricultural vehicles to cloud environment 100 or ground station 110 to cloud environment 100 communication. Such cellular network may be based any known network technology such as SM, GPRS, EDGE, UMTS/HSPA, LTE technologies using standards like 2G, 3G, 4G or 5G. In a local area of an agricultural field, a wireless local area network (WLAN), e.g. Wireless Fidelity (Wi-Fi), may be established for communication. The cellular network for may be a Flying Ad Hoc Network (FANET).

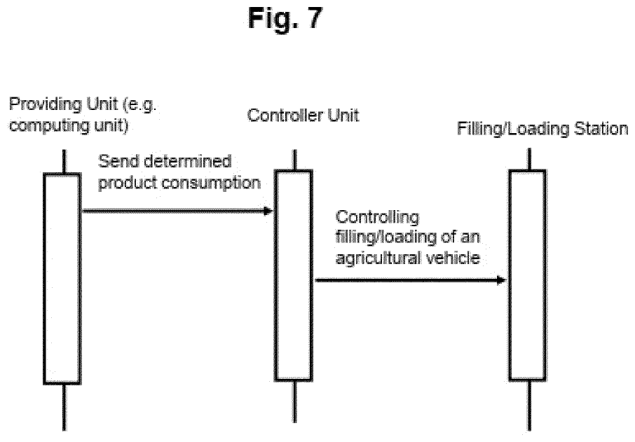

FIG. 7 illustrates one possible data flow diagram of an example method for loading/filling an agricultural vehicle with an agricultural product. As a first data message, a determined product consumption of an agricultural product for an agricultural field is send to a controller unit of a loading or filling station for the agricultural product, wherein the product consumption is determined according to a method as described above. This message is used to control the filling/loading of the agricultural vehicle with the agricultural product according to the determined product consumption needed for the respective agricultural field.

Although illustrative examples of the present disclosure have been described above, in part with reference to the accompanying drawings, it is to be understood that the disclosure is not limited to these examples. Variations to the disclosed examples can be understood and effected by those skilled in the art in practicing the disclosure, from a study of the drawings, the specification and the appended claims.

In the claims, any reference signs placed between parentheses shall not be construed as limiting the claim. The term “comprising” does not exclude the presence of elements or steps other than those listed in a claim. The word “a” or “an” preceding an elements does not exclude the presence of a plurality of such elements. The disclosure can be implemented by means of hardware comprising several distinct elements. In the device claim enumerating several means, several of these means can be embodied by one and the same item of hardware. The mere fact that certain measured are recited in mutually different dependent claims does not indicate that a combination of these measure cannot be used to advantage.

### REFERENCE LIST

10 target application rate map
11, 31, 32 target area
12, 22 greyscale metric
20 application rate map as applied
21, 38, 39, 40, 51 sub-area
30 area
33 target area border
34, 52 route
35, 36 intersection
37, 53 working width
50 area overlap
100 cloud environment
102 agricultural vehicle (e.g. sprayer)
108 user device (e.g. laptop, mobile device)
110 ground station

1. A computer-implemented method for estimating a product consumption of an agricultural product for an agricultural field, the method comprising:
providing a target application rate map (10) comprising an application rate distribution of the agricultural product of the agricultural field, wherein the application rate distribution comprises different target areas with predetermined application rates of the agricultural product (S100);
providing a route (34, 52) of an agricultural vehicle and/or an application device of the agricultural vehicle through the agricultural field for applying the agricultural product (S200);
providing a working width (37, 52) of the agricultural vehicle and/or the application device of the agricultural vehicle;
determining application rates of the agricultural vehicle and/or the application device of the agricultural vehicle at least based on the route (34, 52) of the agricultural vehicle and/or the application device of the agricultural vehicle through the agricultural field (S300); and
determining the product consumption for the agricultural field based on the determined application rates and the working width (37, 53) of the agricultural vehicle and/or the application device of the agricultural vehicle (S400).

2. The method according to claim 1, wherein the step of determining the application rates comprises determining a position of the agricultural vehicle and/or the application device of the agricultural vehicle in the target application rate map (10).

3. The method according to claim 1, wherein the step of determining the product consumption comprises determining a sub-area (21, 38, 39, 40, 51) with a sub-area application rate based on the working width (37, 53) of the agricultural vehicle and/or the application device of the agricultural vehicle and an intersection (35, 36) of the route (34, 52) with a target area border (33) of a target area.

4. The method according to claim 1, wherein the step of determining the product consumption of the agricultural field comprises a summation of the product consumption for the sub-area (21, 38, 39, 40, 51)s, wherein the product consumption for the sub-areas (21, 38, 39, 40, 51) is determined by multiplying the area of the sub-area (21, 38, 39, 40, 51) and the sub-area application rate.

5. The method according to claim 1, further comprising the step of determining a formulation and/or mixture of the agricultural product based on the product consumption for the agricultural field.

6. The method according to claim 1, wherein the target application rate map (10) is based on performance/yield zones of the agricultural field.

7. The method according to claim 1, wherein the route (34, 52) is based on a tramline of the agricultural vehicle and the working width (37, 53) of the agricultural vehicle and/or the application device of the agricultural vehicle.

8. The method according to claim 1, further comprising the step of identifying area overlaps (50) when applying the agricultural product based on the route (34, 52) and the working width (37, 53) and removing the area overlaps (50) when estimating the product consumption for the agricultural field.

9. The method according to claim 1, wherein the application rate is provided by a spray rate for applying a fluid and/or a scattering rate for applying solid.

10. A non-transitory computer-readable medium having instructions encoded thereon that, when executed by a processor of a user device or a server, cause the processor to perform the method according to claim 1.

11. (canceled)

12. A user device comprising a programmable controller configured to perform the method according to claim 1.

13. Use of the determined product consumption according to claim 1 for controlling a controller unit of a loading or filling station for the agricultural product when filling the agricultural product into the agricultural vehicle and/or the application device of the agricultural vehicle.

14. Use of a target application rate map (10), routes (34, 52) of an agricultural vehicle and/or an application device of the agricultural vehicle through an agricultural field in a method according to claim 1.

15. System for estimating a product consumption of an agricultural product for an agricultural field, the system comprising:
a first receiving unit configured to receive a target application rate map (10) comprising an application rate distribution of the agricultural product of the agricultural field, wherein the application rate distribution comprises different target areas with a specific application rate limited by one application rate border (33);
a second receiving unit configured to receive a route (34, 52) of an agricultural vehicle and/or an application device of the agricultural vehicle through the agricultural field for applying the agricultural product;
a third receiving unit configured to receive a working width (37, 52) of the agricultural vehicle and/or the application device of the agricultural vehicle;
a first determining unit configured to determine application rates of the agricultural vehicle and/or the application device of the agricultural vehicle at least based on the route of the agricultural vehicle and/or the application device of the agricultural vehicle through the agricultural field and the working width (37, 53) of the agricultural vehicle and/or the application device of the agricultural vehicle; and
a second determining unit configured to determine the product consumption for the agricultural field based on the determined application rates.

16. A method for applying a product on an agricultural field, the method comprising:
providing a determined product consumption of an agricultural product for an agricultural field according to a method according to claim 1;
controlling a controller unit of a loading or filling station for the agricultural product based on the determined product consumption when filling the agricultural product into an agricultural vehicle; and
applying the agricultural product onto the agricultural field.

17. A system for applying a product on an agricultural field, comprising:
a providing unit for providing a determined product consumption of an agricultural product for an agricultural field according to a method according to claim 1;
a controlling unit for controlling a loading or filling station for the agricultural product based on the determined product consumption when filling the agricultural product into an agricultural vehicle; and
an agricultural vehicle for applying the agricultural product onto the agricultural field.
